(19) United States
(12) Patent Application Publication
(10) Pub. No.: US 2014/0035216 A1
(43) Pub. Date: Feb. 6, 2014

(54) POSITIONING STRUCTURE AND MACHINING DEVICE USING THE SAME

(71) Applicants: HON HAI PRECISION INDUSTRY CO., LTD., New Taipei (TW); FU DING ELECTRONICAL TECHNOLOGY (JIASHAN) CO.,LTD., Zhejiang (CN)

(72) Inventors: JIAN-QIANG LU, Jiashan (CN); JIAN-HUA XU, Jiashan (CN)

(73) Assignees: HON HAI PRECISION INDUSTRY CO., LTD., New Taipei (TW); FU DING ELECTRONICAL TECHNOLOGY (JIASHAN) CO.,LTD., Zhejiang (CN)

(21) Appl. No.: 13/938,362

(22) Filed: Jul. 10, 2013

(30) Foreign Application Priority Data
Aug. 3, 2012 (CN) 2012203828424

(51) Int. Cl. B23Q 3/02

(52) U.S. Cl. CPC B23Q 3/02
USPC 269/309

(57) ABSTRACT

A positioning structure includes a positioning base, a positioning member, a mounting member, a ball, and an elastic member. The positioning base defines a fastening hole. The positioning member is positioned in the fastening hole. The mounting member includes a fixing portion and an assembling portion extending from the fixing portion. The assembling portion is inserted into the positioning member. The fixing portion defines a receiving groove extending to the assembling portion. The assembling portion defines an exposing hole communicating with the receiving groove. The ball is received in the exposing hole. The elastic member is movably inserted into the receiving groove, and resists the ball to be partly exposed from the exposing hole to abut the positioning member, which enable the positioning base to be positioned on the machining device. The present disclosure further provides a machining device using the positioning structure.

### BACKGROUND

1. Technical Field

The present disclosure relates to positioning structures, and particularly, to a positioning structure for positioning at least one workpiece and a machining device using the positioning structure.

2. Description of Related Art

When a workpiece is being machined, a positioning structure may be used for positioning the workpiece. A positioning structure may include a positioning base for supporting the workpiece, and a positioning portion protruding from the positioning base. A platform of a machining device may define a mounting hole. The positioning portion may be inserted into the mounting hole of the platform, for positioning the positioning structure on the platform. However, during the machining process of a plurality of workpieces, a diameter of the mounting hole may become larger and larger due to wear, which results in the positioning structure failing to position the workpiece properly.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of an embodiment of a machining device including a positioning structure and a platform.

FIG. 2 is an assembled, isometric view of the positioning structure and the platform shown in FIG. 1.

FIG. 3 is an exploded, isometric view of the positioning structure shown in FIG. 1.

FIG. 4 is similar to FIG. 3, but shown in another aspect.

FIG. 5 is an assembled, isometric view of the positioning structure shown in FIG. 3.

FIG. 6 is a sectional view along a line VI-VI shown in FIG. 5.

### DETAILED DESCRIPTION

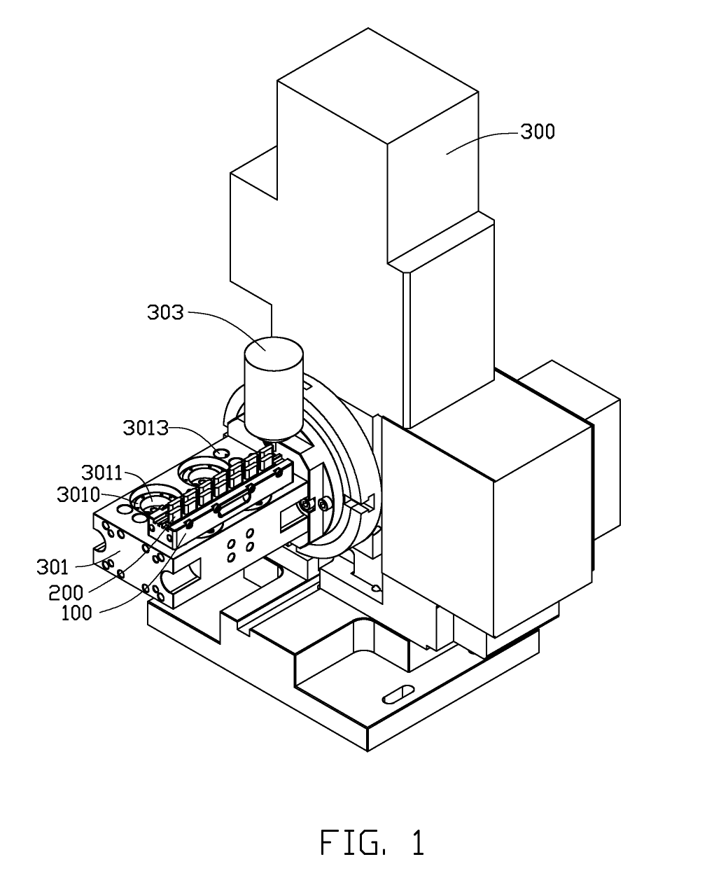

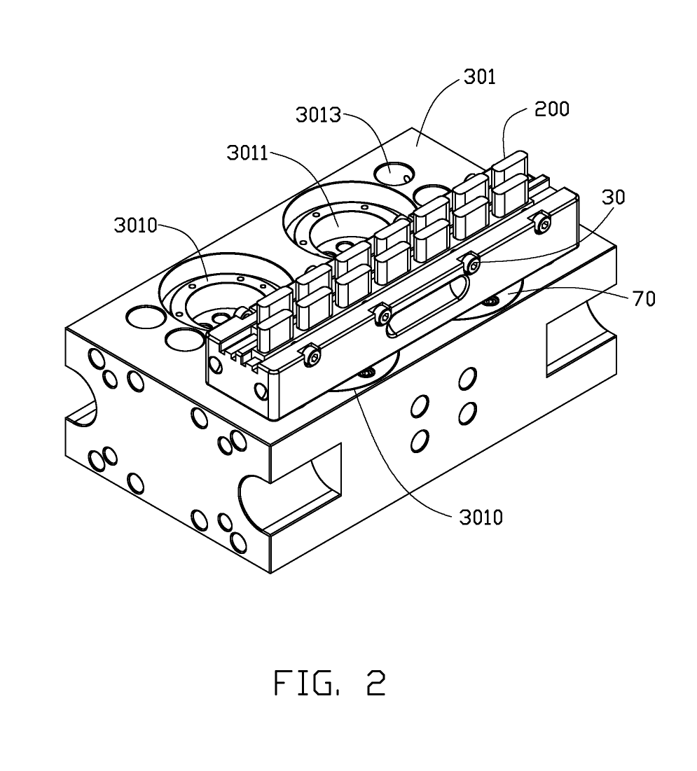

FIGS. 1 and 2 show one embodiment of a machining device 300. The machining device 300 includes a platform 301, a machining mechanism 303, and a positioning structure 100. The platform 301 is mounted on the machining mechanism 303. The positioning structure 100 is positioned on the platform 301, and is configured to position a plurality of workpieces 200. The machining mechanism 303 is partially positioned above the positioning structure 100, for machining the workpieces 200 positioned by the positioning structure 100.

The platform 301 is substantially cubic, and defines four mounting grooves 3010 in a substantially middle portion thereof. The four mounting grooves 3010 are arranged in rows and columns (two of the mounting grooves 3010 are substantially blocked by the positioning structure 100 from view in FIGS. 1 and 2, and the two (blocked from view) mounting grooves 3010 are similar to the two mounting grooves 3010 seen in FIGS. 1 and 2). Each mounting groove 3010 defines a mounting hole 3011 on a bottom surface thereof (two mounting holes 3011 are blocked from view in FIGS. 1 and 2 by the positioning structure 100). The platform 301 further defines eight fixing holes 3013 (in which four of the fixing holes 3013 are blocked from view by the positioning structure 100). Four of the eight fixing holes 3013 are positioned at an end of the platform 301, and the other four of the eight fixing holes 3013 are positioned at an opposite end of the platform 301. Each two or pair of the fixing holes 3013 are located beside one corresponding mounting groove 3010.

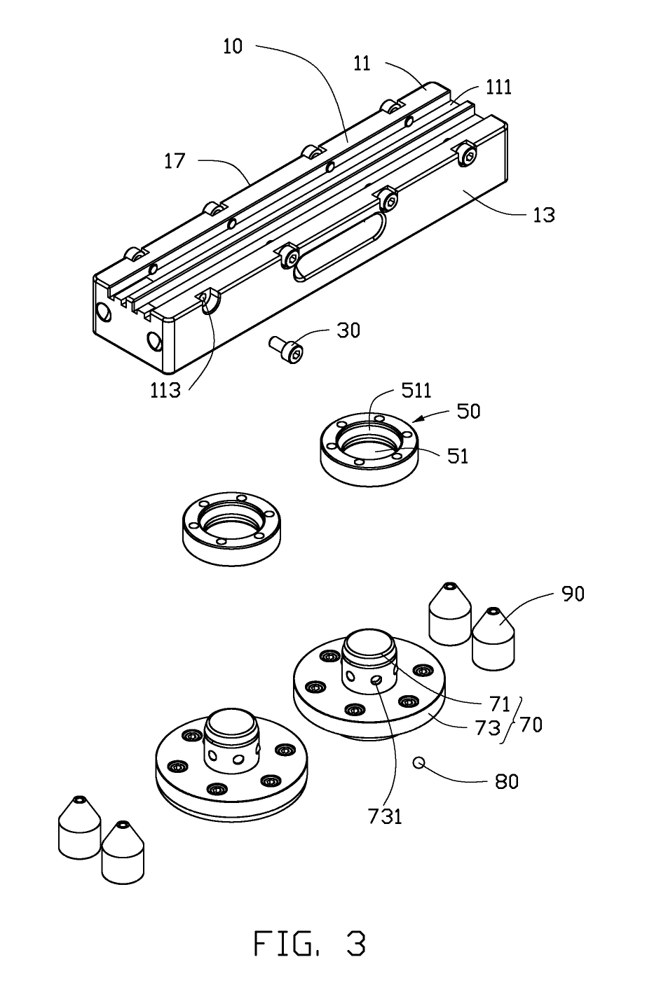

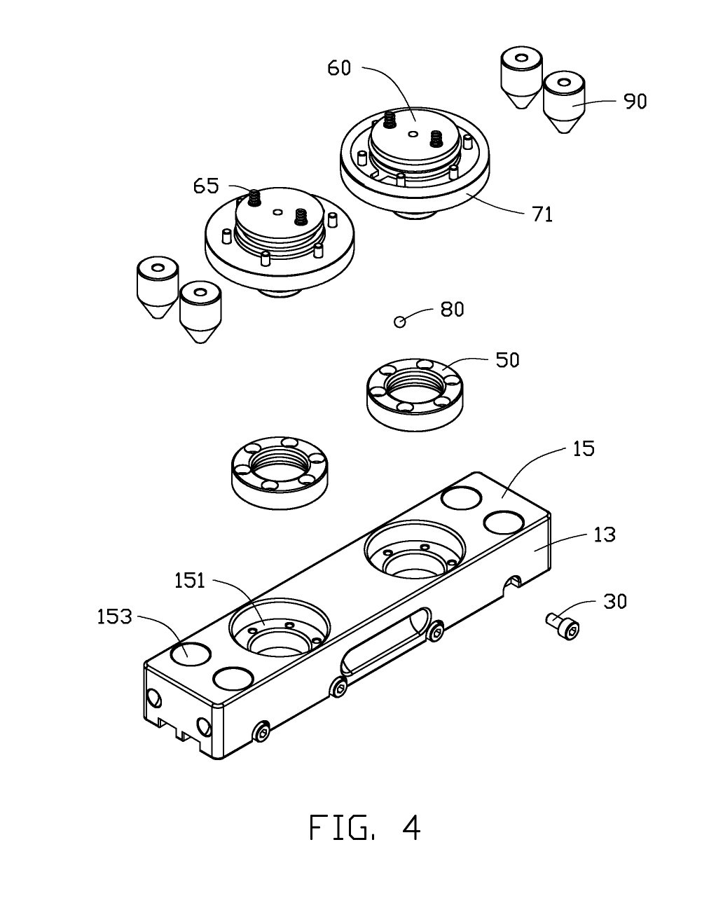

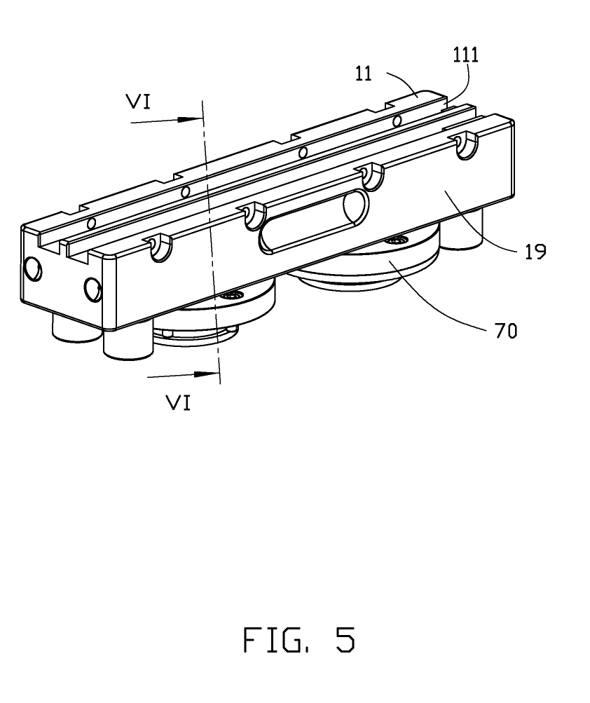

FIGS. 3 through 6 show the positioning structure 100 which includes a positioning base 10, a plurality of fasteners 30, two positioning members 50, two elastic members 60, two mounting members 70, a plurality of balls 80, and four limiting members 90. The positioning base 10 is substantially cubic, and includes a top surface 11, a first side surface 13, a bottom surface 15 opposite to the top surface 11, and a second side surface 17 opposite to the first side surface 13. The top surface 11 and the bottom surface 15 are parallel with each other. The first side surface 13 is parallel with the second side surface 17. Each of the top surface 11 and the bottom surface 15 perpendicularly interconnects the first side surface 13 with the second side surface 17. The top surface 11 defines two parallel installation grooves 111 for positioning the workpieces 200. The first side surface 13 and the second side surface 17 defines a plurality of inserting holes 113 communicating with one corresponding installation groove 111, respectively. The bottom surface 15 defines two fastening holes 151 arranged along a longitudinal direction of the positioning base 10. Two ends of the bottom surface 15 define a pair of limiting holes 153 at each end, respectively, and each pair of limiting holes 153 is arranged along a horizontal direction of the positioning base 10. The fastening holes 151 are located in between the two pairs of the limiting holes 153. In the illustrated embodiment, each fastening hole 151 is substantially a stepped hole.

The plurality of fasteners 30 are respectively mounted on the inserting holes 113 of the first side surface 13 and the second side surface 17, and resist on the workpieces 200 in the installation grooves 111, thereby positioning the workpieces 200 on the positioning base 10. In the illustrated embodiment, the plurality of fasteners 30 are threaded screws, and are respectively threaded into the inserting holes 113.

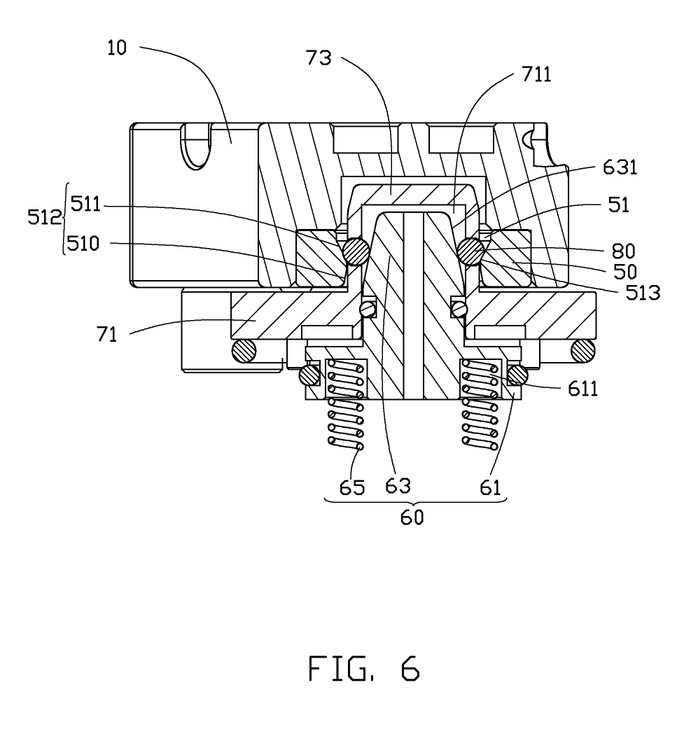

The positioning members 50 are respectively positioned in the fastening holes 151 of the bottom surface 15 of the positioning base 10. The positioning member 50 is substantially disk-like, and defines a through hole 51 along a center axis thereof. The though hole 51 is a stepped through hole in the illustrated embodiment. An inner sidewall 512 of the through hole 51 includes a resisting surface 510 (shown in FIG. 6) and an inclined surface 511 obliquely extending from the resisting surface 510. In the illustrated embodiment, a connecting portion 513 of the resisting surface 510 and the inclined surface 511 is closest to a center axis of the through hole 51.

The elastic members 60 are respectively movably mounted in two of the mounting holes 3011 along the longitudinal direction of the positioning base 10. Each elastic member 60 includes a mounting portion 61, a protruding portion 63 protruding from the mounting portion 61, and a pair of springs 65 mounted on the mounting portion 61 (shown in FIG. 6). The mounting portion 61 defines a pair of receiving holes 611 at a surface thereof away from the protruding portion 63. The protruding portion 63 includes an inclined sidewall 631. The inclined sidewall 631 is closer to an axis of the protruding portion 63 along a direction away from the mounting portion 61. The mounting portion 61 is movably mounted in one corresponding mounting hole 3011. The pair of springs 65 are respectively received in the pair of receiving holes 611. Two ends of each spring 65 respectively resist the mounting portion 61 and the platform 301, thereby the elastic member 60 is movably connected to the platform 301. In an alternative embodiment, a number of the springs 65 may be one or more than two, and there are one or more than two receiving holes 611 correspondingly.

The mounting members 70 are respectively mounted in two corresponding mounting grooves 3010 along the longitudinal direction of the platform 301. Each mounting member 70 is sleeved on the protruding portion 63 of the corresponding elastic member 60, and engaged with the corresponding positioning member 50. Each mounting member 70 includes a fixing portion 71 and an assembling portion 73 extending from the fixing portion 71. Each fixing portion 71 is fixed within the corresponding mounting groove 3010, and defines a receiving groove 711 extending to the assembling portion 73. The assembling portion 73 is inserted into the through hole 51 of the positioning member 50, and resists the resisting surface 510. The assembling portion 73 defines a plurality of exposing holes 731 at a sidewall thereof corresponding to the inclined surface 511. The exposing holes 731 communicate with the receiving groove 711. The plurality of balls 80 are partly received in the plurality of exposing holes 731, and are partly exposed from the corresponding exposing holes 731. The protruding portion 63 of the corresponding elastic member 60 is inserted into the receiving groove 711, and the inclined sidewall 631 movably resists the plurality of balls 80, thus the plurality of balls 80 are sandwiched between the inclined surface 511 and the inclined sidewall 631. When the protruding portion 63 moves towards the assembling portion 73 via the springs 65, the inclined sidewall 631 resists the plurality of balls 80 to be exposed from the exposing holes 731, thus the plurality of balls 80 resists on the inclined surface 511. Thereby, the positioning base 10 is positioned on the mounting member 70.

The four limiting members 90 are fixed on four of the fixing holes 3013 located besides the corresponding two mounting grooves 3010 that are mounting the two mounting members 70. The limiting members 90 are inserted into four corresponding limiting holes 153, respectively, for preventing the positioning base 10 from shaking. In the illustrated embodiment, the limiting members 90 are conic. In an alternative embodiment, the limiting members 90 may be cylindrical, for example.

In assembly, the plurality of fasteners 30 are respectively mounted into the plurality of inserting holes 113. The positioning members 50 are respectively positioned in the fastening holes 151 of the positioning base 10. The assembling portion 73 is inserted into the through hole 51 of the positioning member 50. The balls 80 are received in the exposing holes 731. The protruding portion 63 of the elastic member 60 is movably received in the receiving groove 711. The fixing portion 71 is fixed within the mounting groove 3010, and the mounting portion 61 is partly received in the mounting groove 3010.

In use, first, loosen the fasteners 30, and put the workpieces 200 into the installation grooves 111 of the positioning base 10. Second, the fasteners 30 are threadedly engaged into the inserting holes 113, and resist the workpieces 200, for positioning the workpieces 200. Because the positioning base 10 is positioned on the positioning members 50 and the mounting members 70, the springs 65 are thereby compressed, and apply an elastic force on the mounting portion 61. The protruding portion 63 moves towards the assembling portion 73, and the inclined sidewall 631 resists the balls 80, the balls 80 resists the inclined surface 511, and thus the positioning base 10 is positioned on the platform 301. Fourth, the machining mechanism 303 machines the workpieces 200.

In an alternative embodiment, a number of the mounting groove 3010 may be one or more than one, and a number of the mounting hole 3011, the positioning member 50, the mounting member 70, or the fastening hole 151 may be one or more than one, corresponding to the number of the mounting groove 3010 being present. A number of the fixing holes 3013 may be one or more than one, a number of the limiting member 90 may be one or more than one corresponding to the number of the fixing hole 3013. A number of the installation grooves 111 may be one or more than one.

It is believed that the present embodiments and their advantages will be understood from the foregoing description, and it will be apparent that various changes may be made thereto without departing from the spirit and scope of the embodiments or sacrificing all of its material advantages.

What is claimed is:

1. A positioning structure, for positioning at least one workpiece in a machining device, comprising:
a positioning base defining a fastening hole and a limiting hole;
a positioning member positioned in the fastening hole;
a mounting member comprising a fixing portion and an assembling portion extending from the fixing portion, the fixing portion configured to be positioned on the machining device, the assembling portion inserted into the positioning member, the fixing portion defining a receiving groove extending to the assembling portion, the assembling portion defining an exposing hole communicating with the receiving groove;
a ball received in the exposing hole;
a limiting member configured to be positioned on the machining device, and inserted to the limiting hole; and
an elastic member movably inserted into the receiving groove, and resisting the ball to be partly exposed from the exposing hole to abut the positioning member, thereby enabling the positioning base to be positioned on the machining device.

2. The positioning structure of claim 1, wherein the positioning member defines a through hole, an inner sidewall of the through hole comprises a resisting surface and an inclined surface obliquely extending from the resisting surface, the exposing hole is positioned corresponding to the inclined surface of the inner sidewall of the positioning member, the elastic member is capable of resisting the ball to be exposed from the exposing hole, thus the ball resists the inclined surface of the positioning member.

3. The positioning structure of claim 2, wherein a connecting portion of the resisting surface and the inclined surface is closest to a center axis of the through hole, the assembling portion resists on the resisting surface of the positioning member.

4. The positioning structure of claim 1, wherein the elastic member comprises a mounting portion, a protruding portion protruding from the mounting portion, and a spring mounted on the mounting portion, the protruding portion is inserted into the receiving groove, two ends of the spring resist the mounting portion and the machining device, respectively.

5. The positioning structure of claim 4, wherein the protruding portion comprises an inclined sidewall, the inclined sidewall is closer to an axis of the protruding portion along a direction away from the mounting portion, the inclined sidewall is configured to resist the ball.

6. The positioning structure of claim 5, wherein the mounting portion defines a receiving hole, the spring is received in the receiving hole.

7. The positioning structure of claim 1, wherein the positioning base comprises a top surface, the top surface defines a pair of installation grooves for positioning the at least one workpiece.

8. The positioning structure of claim 7, wherein the positioning base further comprises a first side surface, a bottom surface, and a second side surface, the top surface and the bottom surface respectively perpendicularly connects the first side surface and the second side surface, the fastening hole and the limiting hole are defined on the bottom surface, the first side surface and the second side surface respectively define a plurality of inserting holes, the positioning structure further comprises a plurality of fasteners, the plurality of fasteners are threaded into the plurality of inserting holes, for resisting the at least one workpiece.

9. A machining device, comprising a platform, a machining mechanism, and a positioning structure mounted on the platform, the machining mechanism partially positioned above the positioning structure, for machining at least one workpiece positioned on the positioning structure, the positioning structure comprising:
a positioning base defining a fastening hole and a limiting hole;
a positioning member positioned in the fastening hole;
a mounting member comprising a fixing portion and an assembling portion extending from the fixing portion, the fixing portion positioned on the platform, the assembling portion inserted into the positioning member, the fixing portion defining a receiving groove extending to the assembling portion, the assembling portion defining an exposing hole communicating with the receiving groove;
a ball received in the exposing hole;
a limiting member positioned on the platform, and inserted to the limiting hole; and
an elastic member movably inserted into the receiving groove, and resisting the ball to be partly exposed from the exposing hole to abut the positioning member, which enables the positioning base to be positioned on the platform.

10. The machining device of claim 9, wherein the positioning member defines a through hole, an inner sidewall of the through hole comprises a resisting surface and an inclined surface obliquely extending from the resisting surface, a connecting portion of the resisting surface and the inclined surface is closest to a center axis of the through hole, the exposing hole is positioned corresponding to the inclined surface of the inner sidewall of the positioning member, the assembling portion resists on the resisting surface of the positioning member, the elastic member is capable of resisting the ball to be exposed from the exposing hole, and the ball resists the inclined surface of the positioning member.

11. The machining device of claim 9, wherein the elastic member comprises a mounting portion, a protruding portion protruding from the mounting portion, and a spring mounted on the mounting portion, the protruding portion is inserted into the receiving groove, two ends of the spring respectively resist the mounting portion and the platform.

12. The machining device of claim 11, wherein the protruding portion comprises an inclined sidewall, the inclined sidewall is closer to an axis of the protruding portion along a direction away from the mounting portion, the inclined sidewall is configured to resist the ball.

13. The machining device of claim 11, wherein the platform defines a mounting groove and a fixing hole, the limiting member is positioned in the fixing hole, the fixing portion of the mounting member is fixed within the mounting groove.

14. The machining device of claim 9, wherein the positioning base comprises a top surface, the top surface defines a pair of installation grooves for positioning the at least one workpiece.

15. The machining device of claim 14, wherein the positioning base further comprises a first side surface, a bottom surface, and a second side surface, the top surface and the bottom surface respectively perpendicularly connects the first side surface and the second side surface, the fastening hole and the limiting hole are defined on the bottom surface, the first side surface and the second side surface respectively define a plurality of inserting holes, the positioning structure further comprises a plurality of fasteners, the plurality of fasteners are threaded into the plurality of inserting holes, for resisting the at least one workpiece.

16. A machining device, comprising a platform, a machining mechanism, and a positioning structure mounted on the platform, the positioning structure configured to position at least one workpiece, and comprising:
a positioning base defining a fastening hole;
a positioning member positioned in the fastening hole;
a mounting member comprising a fixing portion and an assembling portion extending from the fixing portion, the fixing portion positioned on the platform, the assembling portion inserted into the positioning member, the fixing portion defining a receiving groove extending to the assembling portion, the assembling portion defining an exposing hole communicating with the receiving groove;
a ball received in the exposing hole; and
an elastic member movably inserted into the receiving groove, and resisting the ball to be partly exposed from the exposing hole to abut the positioning member, which enables the positioning base to be positioned on the platform.

17. The machining device of claim 16, wherein the positioning member defines a through hole, an inner sidewall of the through hole comprises a resisting surface and an inclined surface obliquely extending from the resisting surface, a connecting portion of the resisting surface and the inclined surface is closest to a center axis of the through hole, the exposing hole is positioned corresponding to the inclined surface, the assembling portion resists on the resisting surface of the positioning member, the elastic member is capable of resisting the ball to be exposed from the exposing hole, thus the ball resists the inclined surface of the positioning member.

18. The machining device of claim 16, wherein the elastic member comprises a mounting portion, a protruding portion protruding from the mounting portion, and a spring mounted on the mounting portion, the protruding portion is inserted into the receiving groove, two ends of the spring respectively resist the mounting portion and the platform.

19. The machining device of claim 18, wherein the protruding portion comprises an inclined sidewall, the inclined sidewall is closer to an axis of the protruding portion along a direction away from the mounting portion, the inclined sidewall is configured to resist the ball.

20. The machining device of claim 16, wherein the positioning base comprises a top surface, a first side surface, a bottom surface, and a second side surface, the top surface defines a pair of installation grooves for positioning the at least one workpiece, the fastening hole and the limiting hole are defined on the bottom surface, the first side surface and the second side surface respectively define a plurality of inserting holes, the positioning structure further comprises a plurality of fasteners, the plurality of fasteners are threaded into the plurality of inserting holes, for resisting the at least one workpiece.
